(19) United States
(12) Patent Application Publication
(10) Pub. No.: US 2017/0207851 A1
(43) Pub. Date: Jul. 20, 2017

(54) DATA TRANSMISSION METHOD AND APPARATUS

(71) Applicant: Huawei Technologies Co., Ltd., Shenzhen (CN)

(72) Inventor: Guangzhu Zeng, Hangzhou (CN)

(21) Appl. No.: 15/473,393

(22) Filed: Mar. 29, 2017

Related U.S. Application Data
(63) Continuation of application No. PCT/CN2014/087873, filed on Sep. 30, 2014.

(51) Int. Cl. H04B 10/116; H04B 10/27

(52) U.S. Cl. CPC H04B 10/116; H04B 10/27

(57) ABSTRACT

The present invention provides a data transmission method and apparatus. In the data transmission method, a terminal searches for a visible light network and determines a target visible light network from found visible light networks; then obtains a communication parameter of the target visible light network, establishes, according to the obtained communication parameter corresponding to the target visible light network, a downlink VLC link between the terminal and a VLC device corresponding to the target visible light network, and receives data sent by the VLC device by using the downlink VLC link. Therefore, a part of a traffic intensive downlink service is forwarded to the terminal by using the downlink VLC link, and a transmission rate of an entire wireless communications network is increased.

### CROSS-REFERENCE TO RELATED APPLICATIONS

This application is a continuation of International Application No. PCT/CN2014/087873, filed on Sep. 30, 2014, the disclosure of which is hereby incorporated by reference in its entirety.

### TECHNICAL FIELD

The present invention relates to the field of communications technologies, and in particular, to a data transmission method and apparatus.

### BACKGROUND

With development of wireless communications technologies, an increasing quantity of terminals access a service network by using a wireless communications technology (such as a WiFi communications technology), and almost all the terminals (such as a smartphone and a PAD) support WiFi.

WiFi controls access to a network by using the technology of carrier sense multiple access with collision detection. When more terminals perform communication at the same time in a coverage area of a same wireless network, a probability of access collision also increases. Especially, when multiple terminals in the coverage area of the same wireless network perform traffic intensive service (for example, watching a video) transmission at the same time, noticeable access collision is caused, and a user directly perceives that a wireless transmission rate is excessively low.

VLC (Visible Light Communication, visible light communications) is a communication manner that directly transmits an optical signal over the air by using light in a visible spectrum as an information carrier. VLC communication features a wide spectrum, a high transmission rate, and little interference, and may be used for transmission of a traffic intensive service flow. By using a VLC link to transmit a downlink traffic intensive service in a WiFi communications network, problems of a low transmission rate and severe interference of a downlink traffic intensive service in a wireless communications system can be resolved. However, the VLC requires both sides (such as a terminal and a VLC base station device) of communication to negotiate to determine communication information. The communication information includes parameter information required in a process of establishing a communications link, and parameter information required in a communication process. This requires the terminal to have a VLC uplink sending capability, so that the terminal negotiates with the VLC base station device about the communication information. However, the VLC sending capability may cause high power consumption to the terminal.

### SUMMARY

Embodiments of the present invention provide a data transmission method and apparatus, so as to send downlink data to a terminal in a VLC communication manner. The terminal sends uplink data in another wireless communication manner. Therefore, a data transmission rate of the terminal is increased without causing more power consumption to the terminal.

To achieve the foregoing objective, the following technical solutions are disclosed in the embodiments of the present invention:

According to a first aspect, the present invention provides a data transmission method, including:

searching for, by a terminal, a visible light network, and obtaining identification information corresponding to at least one found visible light network;

determining, by the terminal, a target visible light network according to the identification information of the at least one visible light network;

obtaining, by the terminal, communication parameter information of the target visible light network, and establishing, according to a communication parameter of the target visible light network, a downlink VLC link between the terminal and a visible light communications VLC device corresponding to the target visible light network; and

receiving, by the terminal, data sent by the VLC device by using the downlink VLC link.

With reference to the first aspect, in a first possible implementation manner of the first aspect, the determining, by the terminal, a target visible light network according to the identification information of the at least one visible light network includes:

obtaining, by the terminal, VLC signal quality of the visible light network corresponding to the identification information;

sending, by the terminal by using a non-visible light communications channel, the identification information and the VLC signal quality that are corresponding to the at least one visible light network to a non-visible light wireless access point; and

receiving, by the terminal, identification information that is of the target visible light network and that is sent by the non-visible light wireless access point, where

the target visible light network is determined by the non-visible light wireless access point according to the identification information and the VLC signal quality of the at least one visible light network.

With reference to the first aspect, in a second possible implementation manner of the first aspect, the determining, by the terminal, a target visible light network according to the identification information of the at least one visible light network includes:

obtaining, by the terminal, VLC signal quality of each visible light network corresponding to the identification information; and

determining, by the terminal, a visible light network with best VLC signal quality as the target visible light network.

With reference to any one of the first aspect or the first or the second possible implementation manners of the first aspect, in a third possible implementation manner of the first aspect, the searching for, by a terminal, a visible light network, and obtaining identification information corresponding to at least one found visible light network includes:

measuring, by the terminal, the VLC signal quality of the at least one visible light network; and

obtaining, by the terminal, identification information corresponding to at least one visible light network whose VLC signal quality meets a preset condition.

With reference to the third possible implementation manner of the first aspect, in a fourth possible implementation manner of the first aspect, the obtaining, by the terminal, identification information corresponding to at least one visible light network whose VLC signal quality meets a preset condition includes:

when the visible light network includes multiple VLC cells, obtaining, by the terminal, identification information corresponding to a VLC cell with best VLC signal quality in the multiple VLC cells.

With reference to the first aspect, in a fifth possible implementation manner of the first aspect, the searching for, by a terminal, a visible light network, and obtaining identification information corresponding to at least one found visible light network includes:

receiving, by the terminal by using a non-visible light wireless communications channel, a visible light network search command delivered by a non-visible light wireless access point;

measuring, by the terminal, VLC signal quality of the at least one visible light network according to the visible light network search command; and

obtaining, by the terminal, identification information corresponding to at least one visible light network whose VLC signal quality meets a preset condition.

With reference to the fifth possible implementation manner of the first aspect, in a sixth possible implementation manner of the first aspect, the measuring, by the terminal, VLC signal quality of the at least one visible light network according to the visible light network search command includes:

if the visible light network search command includes specified visible light network identification information, measuring, by the terminal, VLC signal quality of a visible light network corresponding to the specified visible light network identification information; or

if the visible light network search command does not include specified visible light network identification information, measuring, by the terminal, VLC signal quality of a visible light network whose VLC signal can be received.

With reference to any one of the first aspect or the first to the sixth possible implementation manners of the first aspect, in a seventh possible implementation manner of the first aspect, the method further includes:

when the terminal incorrectly receives data that is sent by the VLC device corresponding to the target visible light network by using the downlink VLC link, sending, by the terminal, a first acknowledgment message to the non-visible light wireless access point by using the non-visible light wireless communications channel, where the first acknowledgment message is used to instruct the non-visible light wireless access point to instruct the VLC device to retransmit the data.

With reference to any one of the first aspect or the first to the seventh possible implementation manners of the first aspect, in an eighth possible implementation manner of the first aspect, the method further includes:

when detecting that a visible light network in which the terminal is located changes, sending, by the terminal, a visible light network handover request message to the non-visible light wireless access point by using the non-visible light wireless communications channel, where the visible light network handover request message carries identification information of a new visible light network; and

receiving, by the terminal, a visible light network handover response message sent by a VLC device corresponding to the new visible light network, and handing over to the new visible light network, where

the visible light network handover response message carries communication parameter information of the new visible light network.

According to a second aspect, the present invention provides a data transmission method, including:

sending, by a non-visible light wireless access point, a visible light network search command to a terminal, where the visible light network search command is used to instruct the terminal to search for a visible light network and obtain identification information of a found visible light network;

receiving, by the non-visible light wireless access point, identification information corresponding to at least one visible light network found by the terminal;

determining, by the non-visible light wireless access point, a target visible light network according to the identification information of the at least one visible light network;

sending, by the non-visible light wireless access point, communication parameter information of the target visible light network to the terminal, where the communication parameter information of the target visible light network is used to establish a downlink visible light communications VLC link between the terminal and a visible light communications VLC device corresponding to the target visible light network; and

sending, by the non-visible light wireless access point, data to the VLC device, where the data is sent by the VLC device to the terminal by using the downlink VLC link.

With reference to the second aspect, in a first possible implementation manner of the second aspect, the sending, by the non-visible light wireless access point, communication parameter information of the target visible light network to the terminal includes:

sending, by the non-visible light wireless access point, a first instruction message to the VLC device corresponding to the target visible light network, where the first instruction message is used to instruct the VLC device to send data to the terminal;

receiving, by the non-visible light wireless access point, a second acknowledgment message sent by the VLC device, where the second acknowledgment message includes the communication parameter information of the target visible light network; and

sending, by the non-visible light wireless access point, the communication parameter information of the target visible light network to the terminal by using a non-visible light wireless communications channel.

With reference to the second aspect, in a second possible implementation manner of the second aspect, the sending, by the non-visible light wireless access point, data to the VLC device includes:

determining, by the non-visible light wireless access point, data that is in downlink data and that needs to be forwarded to the terminal by using the downlink VLC link; and

directly sending, by the non-visible light wireless access point, the data that needs to be forwarded to the terminal by using the VLC link to the VLC device corresponding to the target visible light network.

With reference to the second aspect, in a third possible implementation manner of the second aspect, the sending, by the non-visible light wireless access point, data to the VLC device includes:

determining, by the non-visible light wireless access point, data that is in downlink data and that needs to be forwarded to the terminal by using the downlink VLC link; and

sending, by the non-visible light wireless access point, a downlink data forwarding message to a gateway device, so that the gateway device directly sends the data that needs to be forwarded to the terminal by using the downlink VLC link to the VLC device corresponding to the target visible light network, where

the downlink data forwarding message is used to instruct the gateway device to forward, to the VLC device, the data that needs to be forwarded to the terminal by using the downlink VLC link.

According to a third aspect, the present invention provides a data transmission method, including:

receiving, by a visible light communications VLC device, a first instruction message sent by the non-visible light wireless access point, where the first instruction message is used to instruct the VLC device to send data to a terminal;

sending, by the VLC device, a second acknowledgment message to the non-visible light wireless access point, where the second acknowledgment message includes communication parameter information of a target visible light network corresponding to the VLC device, and the communication parameter information of the target visible light network is sent by the non-visible light wireless access point to the terminal, so that the terminal establishes a downlink VLC link between the terminal and the VLC device; and

sending, by the VLC device, data to the terminal by using the downlink VLC link.

With reference to the third aspect, in a first possible implementation manner of the third aspect, the method further includes:

after receiving a first acknowledgment message sent by the terminal, resending, by the VLC device, the data to the terminal by using the downlink VLC link, where

the first acknowledgment message is sent by the terminal to the non-visible light wireless access point by using a non-visible light wireless communications channel, and is sent by the non-visible light wireless access point to the VLC device.

According to a fourth aspect, the present invention provides a terminal, including:

a processor, configured to search for a visible light network, and obtain identification information corresponding to at least one found visible light network; determine a target visible light network according to the identification information of the at least one visible light network; obtain communication parameter information of the target visible light network, and establish, according to a communication parameter of the target visible light network, a downlink VLC link between the terminal and a visible light communications VLC device corresponding to the target visible light network; and

a receiver, configured to receive data sent by the VLC device by using the downlink VLC link.

With reference to the fourth aspect, in a first possible implementation manner of the fourth aspect,

when determining the target visible light network according to the identification information of the at least one visible light network, the processor is specifically configured to: obtain VLC signal quality of the visible light network corresponding to the identification information, and send the identification information and the VLC signal quality that are corresponding to the at least one visible light network to a non-visible light wireless access point by using a non-visible light communications channel; and

the receiver is further configured to receive identification information that is of a target visible light network and that is sent by the non-visible light wireless access point, where the target visible light network is determined by the non-visible light wireless access point according to the identification information and the VLC signal quality of the at least one visible light network.

With reference to the fourth aspect, in a second possible implementation manner of the fourth aspect, when determining the target visible light network according to the identification information of the at least one visible light network, the processor is specifically configured to:

obtain VLC signal quality of each visible light network corresponding to the identification information, and determine a visible light network with best VLC signal quality as the target visible light network.

With reference to any one of the fourth aspect or the first or the second possible implementation manners of the fourth aspect, in a third possible implementation manner of the fourth aspect, when searching for the visible light network, and obtaining the identification information corresponding to the found visible light network, the processor is specifically configured to:

measure VLC signal quality of the at least one visible light network, and obtain identification information corresponding to at least one visible light network whose VLC signal quality meets a preset condition.

With reference to the third possible implementation manner of the fourth aspect, in a fourth possible implementation manner of the fourth aspect, when obtaining the identification information corresponding to the at least one visible light network whose VLC signal quality meets the preset condition, the processor is specifically configured to:

when the visible light network includes multiple VLC cells, obtain, by the terminal, identification information corresponding to a VLC cell with best VLC signal quality in the multiple VLC cells.

With reference to the third possible implementation manner of the fourth aspect, in a fifth possible implementation manner of the fourth aspect, when searching for the visible light network, and obtaining the identification information corresponding to the found visible light network, the processor is specifically configured to:

receive, by using anon-visible light wireless communications channel, a visible light network search command delivered by a non-visible light wireless access point;

measure the VLC signal quality of the at least one visible light network according to the visible light network search command; and

obtain identification information corresponding to the at least one visible light network whose VLC signal quality meets the preset condition.

With reference to the third possible implementation manner of the fourth aspect, in a sixth possible implementation manner of the fourth aspect, when measuring the VLC signal quality of the at least one visible light network according to the visible light network search command, the processor is specifically configured to:

if the visible light network search command includes specified visible light network identification information, measure VLC signal quality of a visible light network corresponding to the specified visible light network identification information; or

if the visible light network search command does not include specified visible light network identification information, measure VLC signal quality of a visible light network whose VLC signal can be received by the terminal.

With reference to any one of the fourth aspect or the first to the sixth possible implementation manners of the fourth aspect, in a seventh possible implementation manner of the fourth aspect, the terminal further includes:

a transmitter, configured to: when the receiving unit incorrectly receives data that is sent by the VLC device corresponding to the target visible light network by using the downlink VLC link, send a first acknowledgment message to the non-visible light wireless access point by using the non-visible light wireless communications channel, where the first acknowledgment message is used to instruct the non-visible light wireless access point to instruct the VLC device to retransmit the data.

With reference to the seventh possible implementation manner of the fourth aspect, in an eighth possible implementation manner of the fourth aspect,

the processor is further configured to detect whether a visible light network in which the terminal is located changes;

the transmitter is further configured to: when the detection unit detects that the visible light network in which the terminal is located changes, send a visible light network handover request message to the non-visible light wireless access point by using the non-visible light wireless communications channel, where the visible light network handover request message carries identification information of a new visible light network; and

the receiver is further configured to receive a visible light network handover response message sent by a VLC device corresponding to the new visible light network, and hand over to the new visible light network, where

the visible light network handover response message carries communication parameter information of the new visible light network.

According to a fifth aspect, the present invention provides a non-visible light wireless access point, including:

a transmitter, configured to send a visible light network search command to a terminal, where the visible light network search command is used to instruct the terminal to search for a visible light network, and obtain identification information corresponding to a found visible light network;

a receiver, configured to receive identification information corresponding to at least one visible light network found by the terminal; and

a processor, configured to determine a target visible light network according to the identification information of the at least one visible light network; where

the transmitter is further configured to send communication parameter information of the target visible light network to the terminal, where the communication parameter information of the target visible light network is used to establish a downlink visible light communications VLC link between the terminal and a visible light communications VLC device corresponding to the target visible light network; and

the transmitter is further configured to send data to the VLC device, where the data is sent by the VLC device to the terminal by using the downlink VLC link.

With reference to the fifth aspect, in a first possible implementation manner of the fifth aspect,

the transmitter is further configured to send a first instruction message to the VLC device corresponding to the target visible light network, where the first instruction message is used to instruct the VLC device to send data to the terminal;

the receiver is further configured to receive a second acknowledgment message sent by the VLC device, where the second acknowledgment message includes the communication parameter information of the target visible light network; and

the transmitter is further configured to send the communication parameter information of the target visible light network to the terminal by using a non-visible light wireless communications channel.

With reference to the fifth aspect, in a second possible implementation manner of the fifth aspect, when sending the data to the VLC device, the transmitter is specifically configured to:

determine data that is in downlink data and that needs to be forwarded to the terminal by using the downlink VLC link; and

directly send the data that needs to be forwarded to the terminal by using the VLC link to the VLC device corresponding to the target visible light network.

With reference to the fifth aspect, in a third possible implementation manner of the fifth aspect, when sending the data to the VLC device, the transmitter is specifically configured to:

determine data that is in downlink data and that needs to be forwarded to the terminal by using the downlink VLC link; and

send a downlink data forwarding message to a gateway device, so that the gateway device directly sends the data that needs to be forwarded to the terminal by using the downlink VLC link to the VLC device corresponding to the target visible light network, where

the downlink data forwarding message is used to instruct the gateway device to forward, to the VLC device, the data that needs to be forwarded to the terminal by using the downlink VLC link.

According to a sixth aspect, the present invention further provides a visible light communications device, including:

a receiver, configured to receive a first instruction message sent by the non-visible light wireless access point, where the first instruction message is used to instruct the VLC device to send data to a terminal; and

a transmitter, configured to send a second acknowledgment message to the non-visible light wireless access point, where the second acknowledgment message includes communication parameter information of a target visible light network corresponding to the VLC device, and the communication parameter information of the target visible light network is sent by the non-visible light wireless access point to the terminal, so that the terminal establishes a downlink VLC link between the terminal and the VLC device; where

the transmitter is further configured to send data to the terminal by using the downlink VLC link.

With reference to the sixth aspect, in a first possible implementation manner of the sixth aspect,

the receiver is further configured to receive a first acknowledgment message sent by the terminal, where the first acknowledgment message is sent by the terminal to the non-visible light wireless access point by using a non-visible light wireless communications channel, and is sent by the non-visible light wireless access point to the VLC device; and

the transmitter is further configured to: after the receiving unit receives the first acknowledgment message sent by the terminal, resend the data to the terminal by using the downlink VLC link.

It can be learned from the foregoing solutions that, in the data transmission method provided in the embodiments of the present invention, a terminal searches for a visible light network, determines a target visible light network from found visible light networks, obtains communication parameter information of the target visible light network, and establishes a downlink VLC link between the terminal and a VLC device corresponding to the target visible light network. Then, the terminal may receive, by using the downlink VLC link, data sent by the VLC device. Therefore, traffic intensive downlink data is forwarded to the terminal by using the downlink VLC link, and a transmission rate of an entire wireless communications network is increased. In addition, the terminal may directly obtain a VLC communication parameter from a received VLC signal or negotiate a VLC communication parameter by using a non-visible light wireless communications channel. Therefore, a terminal side does not need to have a VLC sending capability, and high VLC transmit power consumption of the terminal is avoided. This makes the terminal increase a data transmission rate without causing more noticeable power consumption.

### BRIEF DESCRIPTION OF THE DRAWINGS

Drawings of the specification that constitute a part of the present application are used to provide further understanding of the present invention, and schematic embodiments of the present invention and descriptions thereof are used to explain the present invention, which do not constitute an improper limitation to the present invention. In the accompanying drawings:

FIG. 1 shows a schematic structural diagram of a network structure of a home area network;

FIG. 2 shows a schematic flowchart of a data transmission method according to an embodiment of the present invention;

FIG. 3 shows a schematic flowchart of a method for searching for a visible light network by a terminal according to an embodiment of the present invention;

FIG. 4 shows a schematic flowchart of another data transmission method according to an embodiment of the present invention;

FIG. 5 shows a schematic flowchart of still another data transmission method according to an embodiment of the present invention;

FIG. 6 shows a schematic flowchart of a data transmission method according to an embodiment of the present invention;

FIG. 7 shows a schematic flowchart of a data transmission method according to an embodiment of the present invention;

FIG. 8A and FIG. 8B show a schematic flowchart of a data transmission method according to an embodiment of the present invention;

FIG. 9 shows a schematic structural diagram of another network structure of a home area network;

FIG. 10A and FIG. 10B show a schematic flowchart of a data transmission method based on the home area network shown in FIG. 9;

FIG. 11 shows a schematic diagram of a network architecture of an outdoor wireless network;

FIG. 12 shows a block diagram of a data transmission apparatus according to an embodiment of the present invention;

FIG. 13 shows a block diagram of another data transmission apparatus according to an embodiment of the present invention;

FIG. 14 shows a block diagram of a data transmission apparatus according to an embodiment of the present invention;

FIG. 15 shows a block diagram of a data transmission apparatus according to an embodiment of the present invention;

FIG. 16 shows a schematic structural diagram of a terminal according to an embodiment of the present invention;

FIG. 17 shows a schematic structural diagram of a non-visible light wireless access point according to an embodiment of the present invention; and

FIG. 18 shows a schematic structural diagram of a visible light communications device according to an embodiment of the present invention.

To describe the technical solutions in the embodiments of the present invention more clearly, the following briefly describes the accompanying drawings required for describing the embodiments or the prior art. Apparently, a person of ordinary skill in the art may still derive other drawings from these accompanying drawings without creative efforts.

### DETAILED DESCRIPTION

In a data transmission method provided in embodiments of the present invention, a communication parameter between a terminal and a visible light network is determined by means of negotiation by using a non-visible light wireless communications channel, so that a downlink VLC link between the terminal and the visible light network is established according to the communication parameter. In this way, a VLC sending module does not need to be disposed on a terminal side, and high power consumption is avoided. Further, sending downlink data to the terminal by using the downlink VLC link can improve a transmission rate of an entire wireless network to some extent.

To make a person skilled in the art understand the technical solutions in the present invention better, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

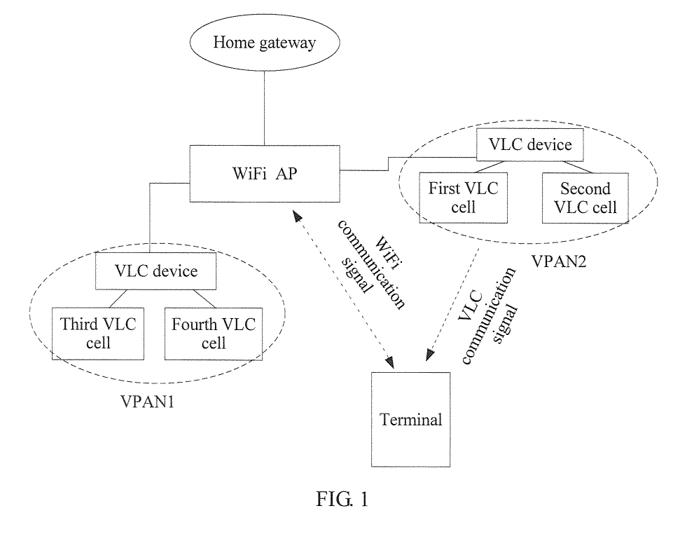

An application scenario of a visible light communications link of the present invention is described first. FIG. 1 shows a schematic diagram of a network architecture of a home area network.

The home area network includes wired and wireless network devices and various terminals. The wireless network device includes various devices that perform communication by using an electromagnetic wave or an optical wave, for example, by using WiFi (Wireless-Fidelity, Wireless Fidelity), Bluetooth, ZigBee, infrared, visible light, or the like.

The home area network shown in FIG. 1 includes a home gateway, a WiFi AP (Access Point, access point), and a VLC device. One VLC device constitutes one visible light network, and the VLC device includes a coordinator and multiple LED light sources. Each LED light source may be a VLC cell. The coordinator is equivalent to an access point of a visible light network. One visible light network may include multiple VLC cells.

In the embodiments of the present invention, a VPAN (VLC Personal Access Network, VLC personal access network) may be used to represent the visible light network.

The network devices in the home area network in FIG. 1 are divided into logical entities, and in actual application, an integrated form of various devices may appear. For example, the home gateway is integrated with a WiFi AP function, or the VLC device is integrated with a WiFi AP function. The network devices in the home area network are connected in a wired manner such as an Ethernet or PLC (power line communication, power line communication) interface.

Compared with VLC, WiFi can penetrate a wall and transmit farther. Therefore, a coverage area of a WiFi AP wireless network may include coverage areas of multiple VLC devices, that is, one WiFi AP may be connected to multiple VLC devices.

In actual application, a user first uses a terminal to connect to the WiFi AP, and the WiFi AP is further connected to the Internet by using the home gateway. When a WiFi air interface is idle, downlink data that occupies relatively large communication bandwidth is transmitted by using a WiFi channel. When a transmission bottleneck appears in the WiFi air interface, the WiFi AP may offload downlink data to a VLC link for transmission. In this case, the WiFi AP needs to make the terminal learn that the downlink data is to be transmitted by using the VLC link, and the terminal needs to enable a corresponding VLC receiving module to receive the downlink data. By using the data transmission method provided in the embodiments of the present invention, only the VLC receiving module needs to be disposed inside the terminal, and a VLC sending module does not need to be disposed.

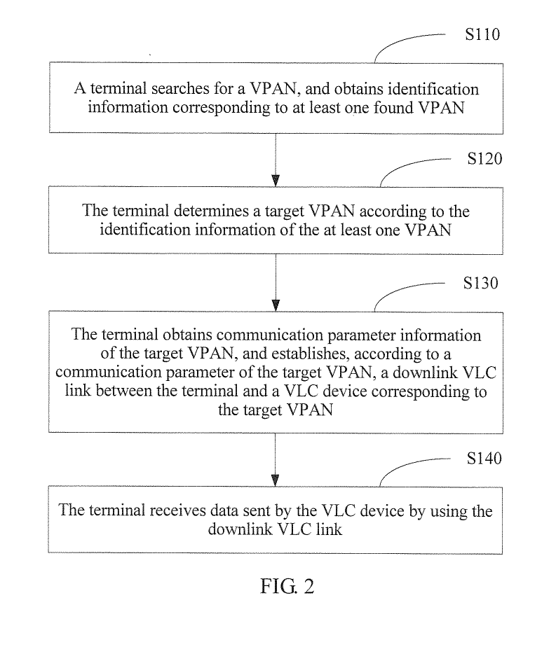

Referring to FIG. 2, FIG. 2 shows a schematic flowchart of a data transmission method according to an embodiment of the present invention. The method is applied to a terminal, and as shown in FIG. 2, the method includes the following steps.

S110. The terminal searches for a VPAN, and obtains identification information corresponding to at least one found VPAN.

In an embodiment of the present invention, the terminal may proactively search for a VLC signal by using a built-in VLC receiving module. By using identification information of a VPAN (such as VPAN ID) corresponding to the VLC signal, the terminal obtains VPAN identification information carried by the VLC signal. For example, when a user enables the VLC receiving module on the terminal, the terminal proactively searches for a VLC signal that can be received.

In another embodiment of the present invention, a non-visible light AP sends a VPAN search command to the terminal by using a non-visible light wireless channel. The terminal searches for a VPAN by using the VLC receiving module according to the VPAN search command, and obtains identification information corresponding to a found VPAN.

In a wireless network area in which the terminal is located, at least one VPAN may be found, and then the terminal can obtain identification information corresponding to the at least one found VPAN.

In this embodiment of the present invention, a VLC signal is received, and identification information of a VPAN corresponding to the received VLC signal is obtained. For example, the terminal can receive three VLC signals that are respectively VLC1, VLC2, and VLC3, VPANs corresponding to the three VLC signals are respectively VPAN1, VPAN2, and VPAN3, and then identification information of the three VPANs, VPAN1, VPAN2, and VPAN3, is obtained.

Alternatively, the terminal searches for a VLC signal, then measures signal quality corresponding to the found VLC signal, and obtains identification information corresponding to a VPAN whose VLC signal quality meets a preset condition. The VLC signal quality may include parameters such as VLC signal strength and a signal-to-noise ratio. For example, if VLC signal strength of the VLC1 and VLC2 among the foregoing VLC1, VLC2, and VLC3 exceeds a preset strength, identification information of the VPAN1 and the VPAN2 is obtained.

Because VPANs have different networking manners, the VPANs may include different quantities of VLC cells, and measurement of corresponding VLC signal quality may be different. If a same VPAN includes multiple VLC cells, the terminal needs to measure a VLC cell with best VLC signal quality, and obtains identification information of the VLC cell.

S120. The terminal determines a target VPAN according to the identification information of the at least one VPAN.

In an embodiment of the present invention, any VPAN corresponding to the identification information may be selected as the target VPAN according to the VPAN identification information. Optionally, the target VPAN may also be determined according to the VLC signal quality, so that a VPAN with the best VLC signal quality is selected to communicate with the terminal.

A process of determining the target VPAN according to the VLC signal quality may be implemented in the following two manners:

I. A Non-Visible Light Wireless AP Determines the Target VPAN

Step (11): The terminal obtains VLC signal quality of the at least one VPAN.

Step (12): The terminal sends the identification information and the VLC signal quality of the at least one VPAN to the non-visible light wireless AP by using a non-visible light communications channel, where the target VPAN is determined by the non-visible light wireless AP according to the identification information and the VLC signal quality of the at least one VPAN.

Step (13): The terminal receives identification information of the target VPAN sent by the non-visible light wireless AP.

II. The Terminal Determines the Target VPAN

Step (21): The terminal obtains VLC signal quality of each VPAN corresponding to the identification information.

Step (22): The terminal determines a VPAN with best VLC signal quality as the target VPAN.

S130. The terminal obtains communication parameter information of the target VPAN, and establishes, according to a communication parameter of the target VPAN, a downlink VLC link between the terminal and a visible light communications VLC device corresponding to the target VPAN.

The communication parameter information of the target VPAN includes parameters such as a transmission mode, a modulation and coding scheme, and a MAC address of the VPAN.

If the terminal determines the target VPAN, a VLC signal sent by the target VPAN carries the communication parameter information of the target VPAN. After obtaining the communication parameter information of the target VPAN, the terminal configures a VLC parameter of the terminal, and establishes the downlink VLC link between the terminal and the target VPAN.

If the non-visible light wireless AP determines the target VPAN, the non-visible light wireless AP obtains the communication parameter information of the target VPAN, and sends the communication parameter information to the terminal by using the non-visible light wireless communications channel. The terminal configures the VLC parameter of the terminal according to the communication parameter of the target VPAN, and establishes the downlink VLC link between the terminal and the target VPAN. If a VPAN includes multiple VLC cells, after determining the target VPAN, a WiFi AP needs to forward identification information of VLC cells in the target VPAN to a VLC device corresponding to the target VPAN, so that the VLC device sends communication parameters of the VLC cells to the WiFi AP according to identities of the VLC cells.

In a preferred embodiment of the present invention, to check communication quality of the established downlink VLC link between the terminal and the target VPAN, after the downlink VLC link is established or before certain downlink data is transmitted, the VLC device sends a reference signal by using the downlink VLC link, and the terminal detects link status information of the downlink VLC link according to the reference signal, and feeds back the link status information to the WiFi AP.

S140. The terminal receives data sent by the VLC device by using the downlink VLC link.

In the data transmission method provided in this embodiment, the terminal searches for a VPAN, and determines a target VPAN from found VPANs. Then, the terminal obtains a communication parameter of the target VPAN, establishes, according to the obtained communication parameter corresponding to the target VPAN, a downlink VLC link between the terminal and a VLC device corresponding to the target VPAN, and receives data sent by the VLC device by using the downlink VLC link. Therefore, a part of traffic intensive downlink data is forwarded to the terminal by using the downlink VLC link, and a transmission rate of an entire wireless communications network is increased. In addition, a communication parameter of the VLC link is determined by means of negotiation by using a non-visible light wireless communications channel. Therefore, a VLC sending module does not need to be disposed inside the terminal, and high power consumption of the terminal is avoided.

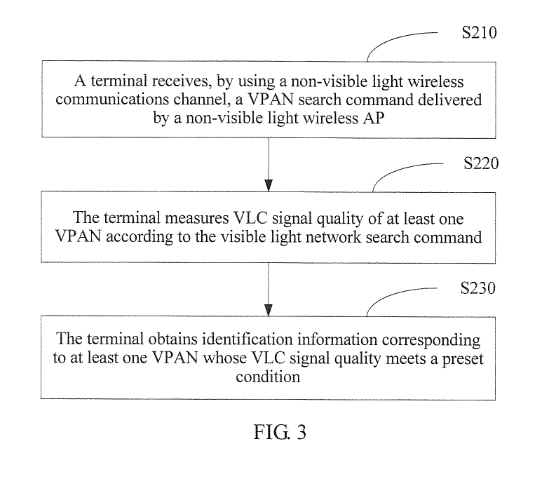

Referring to FIG. 3, FIG. 3 shows a schematic flowchart of a method for searching for a VPAN by a terminal according to an embodiment of the present invention. The method is applied to a terminal, and as shown in FIG. 3, the method includes the following steps.

S210. The terminal receives, by using a non-visible light wireless communications channel, a VPAN search command delivered by a non-visible light wireless AP.

In this embodiment, a WiFi AP is used as an example of the non-visible light wireless AP for description. The WiFi AP delivers the VPAN search command to the terminal by using a WiFi channel between the WiFi AP and the terminal. After receiving downlink data and determining that the downlink data needs to be forwarded to the terminal by using a downlink VLC link, the WiFi AP delivers the VPAN search command to the terminal.

In an embodiment of the present invention, if the WiFi AP already learns specific distribution of VPANs in a coverage area of the wireless network, identification information, for example, VPAN ID, of a VPAN in the wireless network may be carried in the VPAN search command, and may be stored in a first VPAN ID list. Actually, the identification information of the VPAN is identification information of a VLC device corresponding to the VPAN, and may be a device name that uniquely identifies the VLC device.

In another embodiment of the present invention, the visible light network search command may not carry the first VPAN ID list.

S220. The terminal measures VLC signal quality of at least one VPAN according to the VPAN search command.

After receiving the VPAN search command, the terminal uses a VLC receiving module of the terminal to search for a VLC signal, and obtains identification information of a found VPAN. Optionally, out of consideration for power saving, before the terminal searches for a VPAN, the VLC receiving module is usually in a disabled state. When the VPAN search command delivered by the WiFi AP is received, a receiving function of the VLC receiving module needs to be first enabled, so that the terminal can normally receive a VLC signal.

When the VPAN search command includes the first VPAN ID list, the terminal attempts to search for a VLC signal of a VPAN included in the first VPAN ID list, and identification information of VPANs included in the first VPAN ID list and found by the terminal constitutes a second VPAN ID list. When the visible light search command does not include the first VPAN ID list, the terminal searches for a VPAN whose VLC signal can be received, and identification information corresponding to found VPANs constitutes a second VPAN ID list.

It should be noted that the first VPAN ID list includes multiple VPANs in the coverage area of the wireless network in which the terminal is located, while the second VPAN ID list only includes a VPAN whose VLC signal can be received by the terminal. In other words, the second VPAN ID list may be a subset of the first VPAN ID list.

S230. The terminal obtains identification information corresponding to at least one VPAN whose VLC signal quality meets a preset condition.

After finding the VPAN, the terminal further obtains, according to VLC signal quality of the VPAN, the identification information of the VPAN whose VLC signal quality meets the preset condition. Reference may be made to the embodiment shown in FIG. 1, and details are not repeatedly described herein.

In the method for searching for a VPAN provided in this embodiment, only after receiving a VPAN search command delivered by a non-visible light wireless AP, the terminal searches for a VPAN, and obtains identification information corresponding to a VPAN whose VLC signal quality meets a preset condition. This avoids a phenomenon of power consumption and a resource waste of a terminal caused by continuous search after the terminal enables a VLC receiving module.

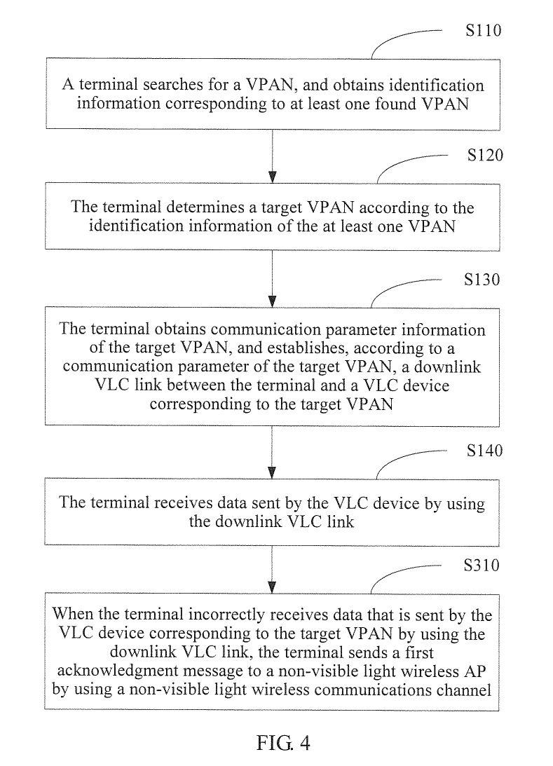

Referring to FIG. 4, FIG. 4 shows a schematic flowchart of another data transmission method according to an embodiment of the present invention. The method is applied to a terminal, and as shown in FIG. 4, on a basis of the embodiment shown in FIG. 1, the method may further include the following step:

S310. When the terminal incorrectly receives data that is sent by the VLC device corresponding to the target VPAN by using the downlink VLC link, the terminal sends a first acknowledgment message to the non-visible light wireless AP by using the non-visible light wireless communications channel, where the first acknowledgment message is used to instruct the non-visible light wireless AP to instruct the VLC device to retransmit the data.

If a STA correctly receives the data that is sent by the VLC device by using the downlink VLC link, the first acknowledgment message is an ACK (acknowledgement, acknowledgment character) packet, and when receiving the ACK packet, the VLC device determines that there is no need to resend the data to the STA. If the STA does not correctly receive the data that is sent by the VLC device by using the downlink VLC link, the first acknowledgment message is an NCK (Negative acknowledgement, negative acknowledgment) packet, and the VLC device resends the data according to the NCK packet.

In the data transmission method provided in this embodiment, when a terminal does not correctly receive data that is sent by using a downlink VLC link by a VLC device corresponding to a target VPAN, the terminal sends a first acknowledgment message to a non-visible light wireless AP, and the non-visible light wireless AP instructs the VLC device to resend the data. This improves correctness of data transmission.

It may be learned according to the home area network shown in FIG. 1 that a wireless network area covered by a WiFi AP may include multiple VPANs, and each VPAN may include multiple VLC cells. Because a STA has mobility, the STA may move between VLC cells, and may even move between different VPANs. However, a STA provided in this embodiment of the present invention has no VLC uplink sending function. Therefore, network side devices (a WiFi AP and a VLC device) do not learn a movement handover event of the STA.

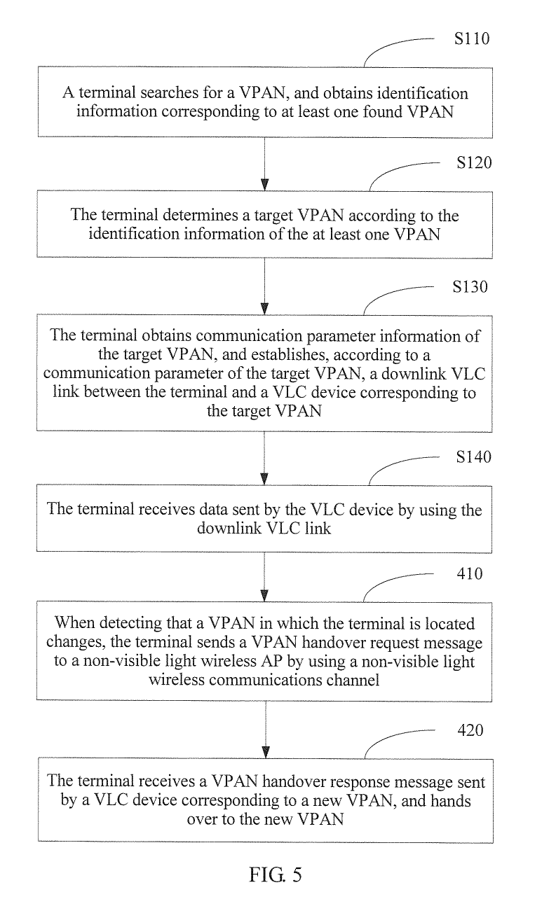

Referring to FIG. 5, FIG. 5 shows a schematic flowchart of another data transmission method according to an embodiment of the present invention. The method is applied to a terminal, and as shown in FIG. 5, on a basis of the embodiment shown in FIG. 1, the method may further include the following steps:

S410. When detecting that a VPAN in which the terminal is located changes, the terminal sends a VPAN handover request message to the non-visible light wireless AP by using the non-visible light wireless communications channel, where the VPAN handover request message carries identification information of a new VPAN.

S420. The terminal receives a VPAN handover response message sent by a VLC device corresponding to the new VPAN, and hands over to the new VPAN, where the VPAN handover response message carries communication parameter information of the new VPAN.

If a VLC coverage area of the terminal changes from a first VLC cell to a second VLC cell, the VPAN handover request message includes identification information (such as VLC CELL ID2) of the second VLC cell, and the WiFi AP sends the VPAN handover request message to the VLC device. After receiving the VPAN handover request message, the VLC device adds a communication parameter of the second VLC cell into the VPAN handover response message and sends the VPAN handover response message to the WiFi AP. Then, the WiFi AP sends the VPAN handover response message to the terminal by using a WiFi channel. Finally, downlink data of the STA is switched from the first VLC cell to the second VLC cell.

If the VLC coverage area of the terminal changes from a first VPAN to a second VPAN, the terminal sends a VPAN handover request message that carries identification information of the second VPAN to the WiFi AP. Then the WiFi AP forwards the VPAN handover request message to a VLC device corresponding to the second VPAN. After receiving the VPAN handover request message, the VLC device corresponding to the second VPAN returns a VPAN handover response message to the terminal, and the handover response message carries a VLC communication parameter of the second VPAN. Finally, downlink data of the STA is switched from the first VPAN to the second VPAN.

In the data transmission method provided in this embodiment, a terminal detects a change of a VPAN in which the terminal is located, and reports a VPAN in which the terminal is currently located to a non-visible light wireless AP by using a non-visible light wireless communications channel. The terminal and the non-visible light wireless AP determine a VLC parameter by means of negotiation by using a non-visible light wireless communications channel, so as to implement a VPAN handover.

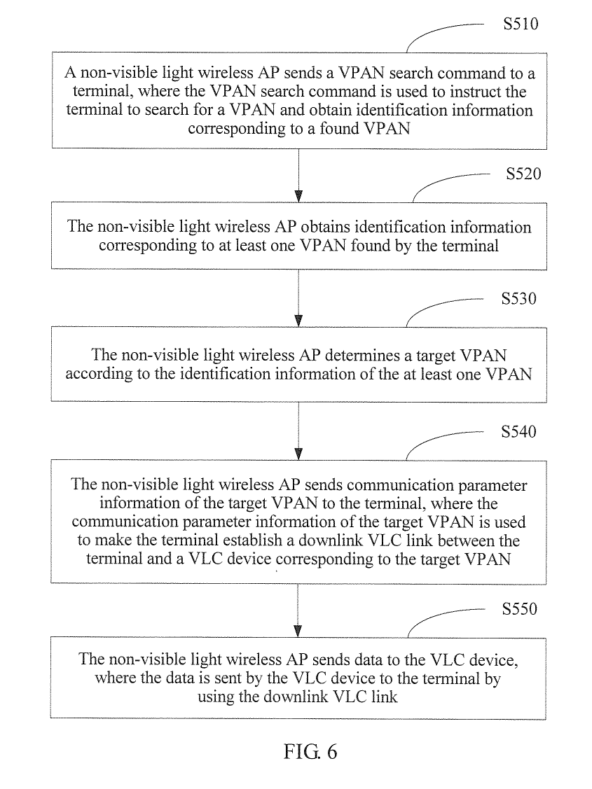

Referring to FIG. 6, FIG. 6 shows a schematic flowchart of a data transmission method according to an embodiment of the present invention. The method is applied to a non-visible light wireless access point, and as shown in FIG. 6, the method includes the following steps.

S510. The non-visible light wireless AP sends a VPAN search command to a terminal, where the VPAN search command is used to instruct the terminal to search for a VPAN and obtain identification information corresponding to a found VPAN.

S520. The non-visible light wireless AP obtains identification information corresponding to at least one VPAN found by the terminal.

S530. The non-visible light wireless AP determines a target VPAN according to the identification information of the at least one VPAN.

S540. The non-visible light wireless AP sends communication parameter information of the target VPAN to the terminal, where the communication parameter information of the target VPAN is used to make the terminal establish a downlink VLC link between the terminal and a VLC device corresponding to the target VPAN.

In this embodiment of the present invention, step S540 may be implemented by using the following step (31) to step (33).

Step (31): The non-visible light wireless AP sends a first instruction message to the VLC device corresponding to the target VPAN, where the first instruction message is used to instruct the VLC device to send data to the terminal.

A WiFi AP instructs, by using the first instruction message, the VLC device corresponding to the target VPAN to enable a service function of transmitting data to the STA.

The first instruction message includes identification information (an IP packet 5-tuple) of downlink data and a destination address (an address of the terminal).

If the target VPAN includes multiple VLC cells, the WiFi AP adds received identification information of a VLC cell into the first instruction message and sends the first instruction message to the VLC device corresponding to the target VPAN.

Step (32): The non-visible light wireless AP receives a second acknowledgment message sent by the VLC device, where the second acknowledgment message includes communication parameter information of the target VPAN.

Step (33): The non-visible light wireless AP sends the communication parameter information of the target VPAN to the terminal by using the non-visible light wireless communications channel.

S550. The non-visible light wireless AP sends data to the VLC device, where the data is sent by the VLC device to the terminal by using the downlink VLC link.

In the data transmission method provided in this embodiment, a non-visible light wireless AP determines a communication parameter between a terminal and a VPAN by means of negotiation with the terminal by using a non-visible light wireless communications channel, so as to establish a VLC link between the terminal and the VPAN. A part of traffic intensive data is forwarded to the terminal by using the VLC link, and a wireless network transmission rate is increased. Because a VLC communication parameter is determined by means of negotiation by using the non-visible light wireless communications channel, a VLC sending module does not need to be disposed inside the terminal, and high power consumption of the terminal is avoided.

Referring to FIG. 7, FIG. 7 shows a schematic flowchart of a data transmission method according to an embodiment of the present invention. The method is applied to a VLC device. As shown in FIG. 7, the method includes the following steps:

S610. The VLC device receives a first instruction message sent by the non-visible light wireless AP, where the first instruction message is used to instruct the VLC device to send data to a terminal.

S620. The VLC device sends a second acknowledgment message to the non-visible light wireless AP, where the second acknowledgment message includes communication parameter information of a target VPAN corresponding to the VLC device, and the communication parameter information of the target VPAN is sent by the non-visible light wireless AP to the terminal, so that the terminal establishes a downlink VLC link between the terminal and the VLC device.

S630. The VLC device sends data to the terminal by using the downlink VLC link.

After receiving data sent by the non-visible light wireless AP, the VLC device determines, according to the received data, the downlink VLC link for sending the data to the terminal, and then sends the data to the terminal by using the downlink VLC link.

Optionally, the method embodiment shown in FIG. 7 may further include the following step:

S640. After receiving a first acknowledgment message sent by the terminal, the VLC device resends the data to the terminal by using the downlink VLC link.

The first acknowledgment message is sent by the terminal to the non-visible light wireless access point by using a non-visible light wireless communications channel, and is sent by the non-visible light wireless access point to the VLC device.

In the data transmission method provided in this embodiment, a non-visible light wireless AP sends a part of traffic intensive data to a VLC device, and the VLC device sends the data to a terminal by using a downlink VLC link, thereby increasing a wireless network transmission rate. In addition, a VLC parameter is determined by means of negotiation by using a non-visible light wireless communications channel. Therefore, a VLC sending module does not need to be disposed inside the terminal, and high power consumption of the terminal is avoided.

The following describes a data transmission method provided in the present invention by using an example of two specific application scenarios.

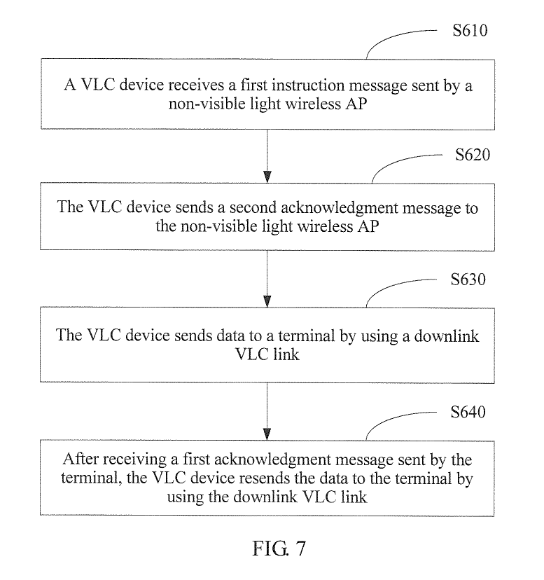

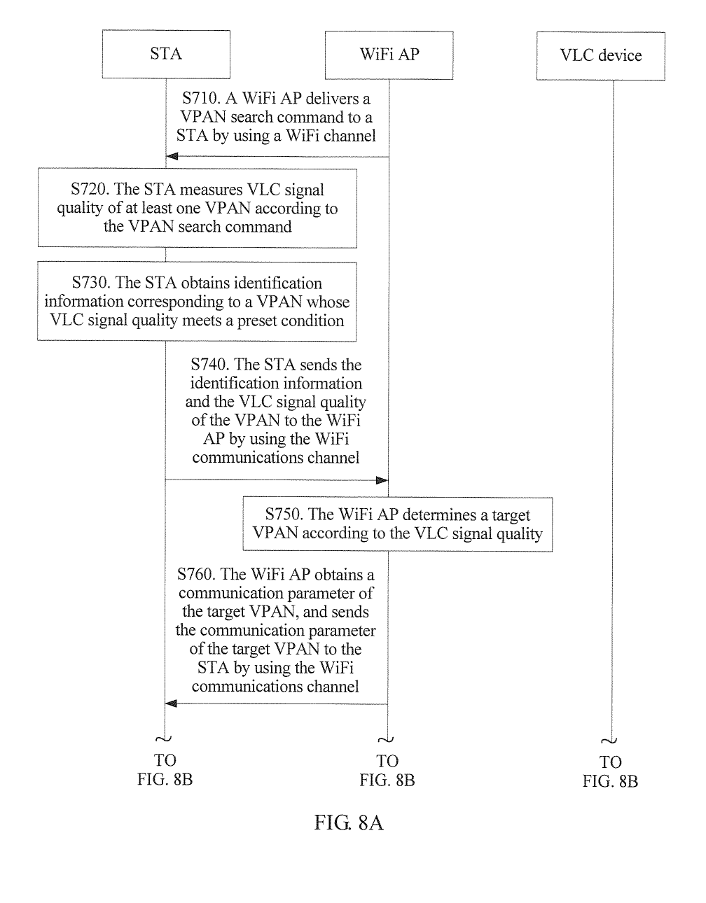

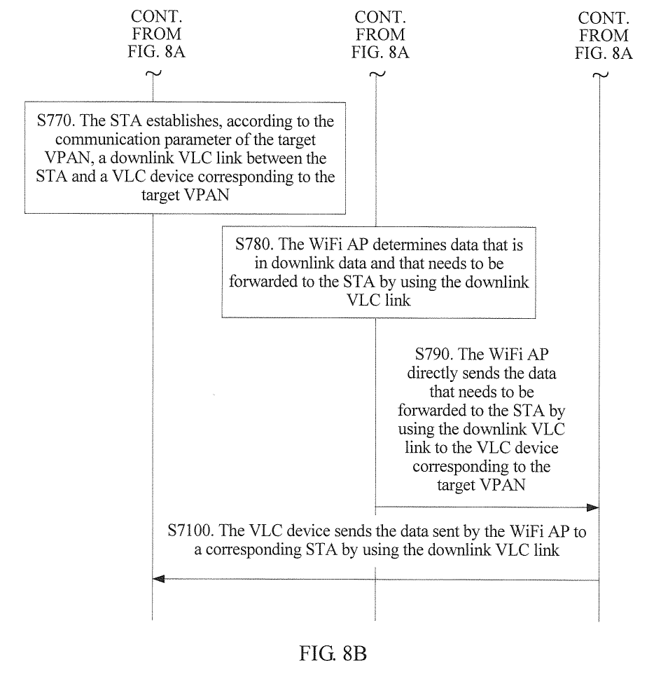

Referring to FIG. 8A and FIG. 8B, FIG. 8A and FIG. 8B show a flowchart of a data transmission method according to an embodiment of the present invention. The method is applied to the home area network shown in FIG. 1. The home area network is in a wireless network system including a STA (Station, terminal), a WiFi AP, and a VLC device (VLC coordinator). The WiFi AP is connected to the VLC device in a wired communication manner, and the WiFi AP and the VLC device has a one-to-many relationship. As shown in FIG. 8A and FIG. 8B, the method includes the following steps:

S710. The WiFi AP delivers a VPAN search command to the STA by using a WiFi channel.

S720. The STA measures VLC signal quality of at least one VPAN according to the VPAN search command.

S730. The STA obtains identification information corresponding to a VPAN whose VLC signal quality meets a preset condition.

S740. The STA sends the identification information and the VLC signal quality of the VPAN to the WiFi AP by using the WiFi communications channel.

S750. The WiFi AP determines a target VPAN according to the VLC signal quality.

S760. The WiFi AP obtains a communication parameter of the target VPAN, and sends the communication parameter of the target VPAN to the STA by using the WiFi communications channel.

For a process in which the WiFi AP obtains the communication parameter of the target VPAN, refer to corresponding content in the foregoing embodiments, and details are not repeatedly described herein.

S770. The STA establishes, according to the communication parameter of the target VPAN, a downlink VLC link between the STA and a VLC device corresponding to the target VPAN.

S780. The WiFi AP determines data that is in downlink data and that needs to be forwarded to the STA by using the downlink VLC link.

The WiFi AP may determine, according to a preset rule, data that needs to be transmitted by using the downlink VLC link. The preset rule may include but is not limited to the following two manners:

(1) Preset a traffic threshold for downlink data. The preset threshold may be traffic that needs to be used for transmitting the data. For example, the traffic threshold for the downlink data is 20 Mbps; and when traffic that needs to be used for the downlink data exceeds 20 Mbps, it is determined that the downlink data needs to be forwarded by using the downlink VLC link.

(2) Preset a type of the downlink data that needs to be forwarded by using the downlink VLC link. For example, if a video is preset as a type of data that needs to be forwarded by using the downlink VLC link, when determining that the type of the downlink data is a video, the WiFi AP determines that the downlink data needs to be forwarded by using the downlink VLC link.

If it is determined that the downlink data is not the data that needs to be forwarded by using the downlink VLC link, the WiFi AP directly sends the downlink data to the STA by using the WiFi channel.

S790. The WiFi AP directly sends the data that needs to be forwarded to the STA by using the downlink VLC link to the VLC device corresponding to the target VPAN.

S7100. The VLC device sends the data sent by the WiFi AP to a corresponding STA by using the downlink VLC link.

After receiving the data, the VLC device first searches for, according to identification information (an IP packet 5-tuple) of the data, a downlink VLC link for transmitting the data, and then forwards the received data to the STA by using the downlink VLC link.

In the data transmission method provided in this embodiment, a STA and a VLC device negotiate a VLC communication parameter by using a non-visible light wireless communications channel, and further establish a downlink VLC link between the STA and the VLC device. A non-visible light wireless AP may directly send traffic intensive data in downlink data to the VLC device, and then the VLC device sends the data to the STA by using the downlink VLC link. A VLC sending module does not need to be disposed inside a terminal, so that high power consumption of the terminal is avoided.

Referring to FIG. 9, FIG. 9 shows a schematic structural diagram of another home area network architecture according to an embodiment of the present invention. A difference from the home area network shown in FIG. 1 is that a VLC device (VLC coordinator) is directly connected to a home gateway (HGW).

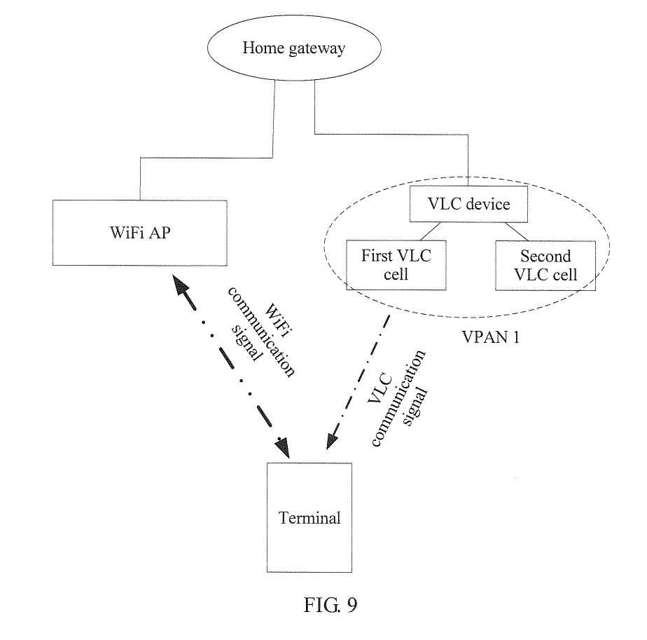

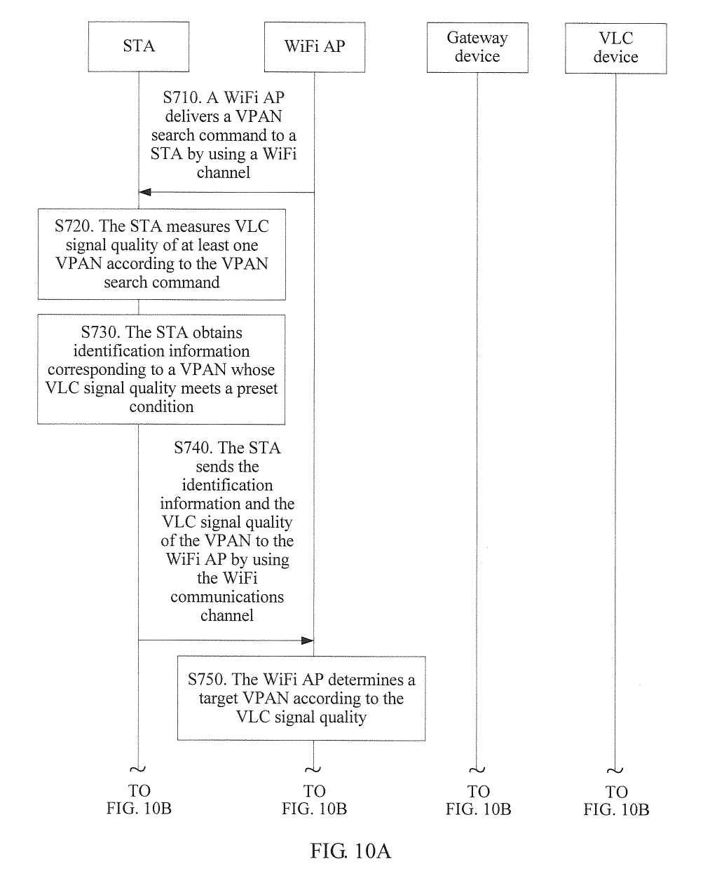

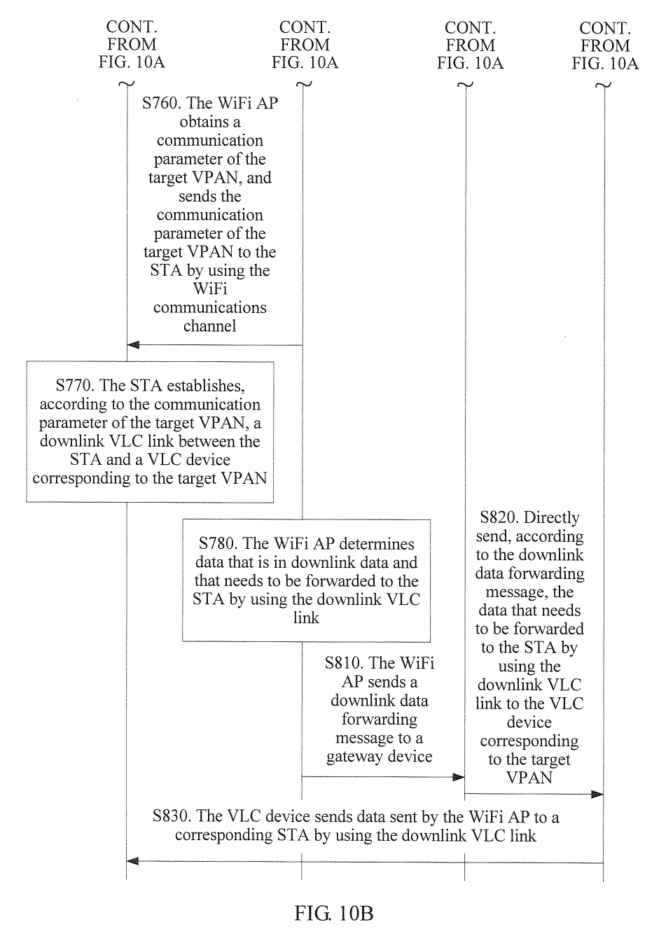

Referring to FIG. 10A and FIG. 10B, FIG. 10A and FIG. 10B show a flowchart of another data transmission method according to an embodiment of the present invention. The method is applied to the home area network shown in FIG. 9. Different from the method shown in FIG. 8A and FIG. 8B, in this method, a gateway device directly sends, to a VLC device, data that needs to be forwarded to a STA by using a downlink VLC link. As shown in FIG. 10A and FIG. 10B, the method may include the following steps:

S710. A WiFi AP delivers a VPAN search command to a STA by using a WiFi channel.

S720. The STA measures VLC signal quality of at least one VPAN according to the VPAN search command.

S730. The STA obtains identification information corresponding to a VPAN whose VLC signal quality meets a preset condition.

S740. The STA sends the identification information and the VLC signal quality of the VPAN to the WiFi AP by using the WiFi communications channel.

S750. The WiFi AP determines a target VPAN according to the VLC signal quality.

S760. The WiFi AP obtains a communication parameter of the target VPAN, and sends the communication parameter of the target VPAN to the STA by using the WiFi communications channel.

S770. The STA establishes, according to the communication parameter of the target VPAN, a downlink VLC link between the STA and a VLC device corresponding to the target VPAN.

S780. The WiFi AP determines data that is in downlink data and that needs to be forwarded to the STA by using the downlink VLC link.

S810. The WiFi AP sends a downlink data forwarding message to a gateway device.

The downlink data forwarding message includes identification information of the downlink data and identification information of the VLC device corresponding to the target VPAN. The identification information of the downlink data is usually an IP packet 5-tuple, and the IP packet 5-tuple includes a source IP address, a destination IP address, an IP protocol number, a source IP port number, and a destination IP port number of a packet. The identification information of the VLC device may be a MAC address of an Ethernet interface of the VLC device, or may be a device name that can uniquely identify the VLC device in a home area network.

S820. The gateway device directly sends, according to the downlink data forwarding message, data that needs to be forwarded to the STA by using the downlink VLC link to the VLC device corresponding to the target VPAN.

S830. The VLC device receives the data sent by the gateway device, and sends the data to the STA by using the downlink VLC link.

VLC communication may be applied to an indoor application scenario of a wireless network. In addition, outdoor VLC communication may also be implemented by using a cellular network or a WiFi network.

The cellular network may be a macro base station, a micro base station, or a small cell, while the VLC communication is most likely to be deployed in combination with a small cell.

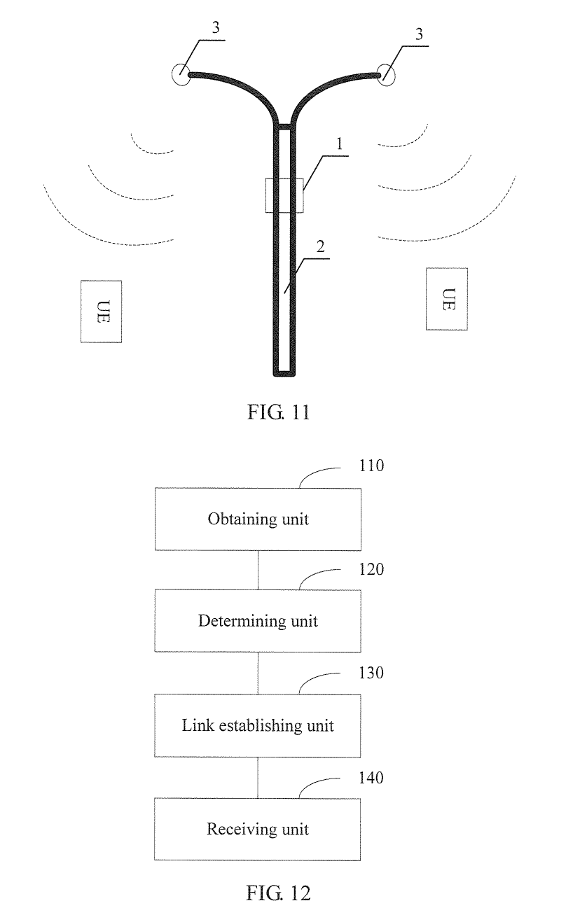

Generally, a street lamp post is installed on a roadside or a square. As shown in FIG. 11, a small cell 1 may be bound to a street lamp post 2 to implement cellular network coverage. VLC devices may be integrated into the small cell 1, or may be integrated into a street lamp 3. In this case, the small cell 1 is connected to a core network by using a wired backhaul network or a wireless backhaul network. A backhaul network is installed in the street lamp post 2 when the small cell 1 is installed. Therefore, when implementing visible light communications, the street lamp 3 may share the backhaul network of the small cell 1 with the small cell 1.

A method in which an outdoor terminal transmits data by using a cellular network is similar to the foregoing method embodiments. The small cell 1 in this embodiment is equivalent to the WiFi AP in the foregoing method embodiments. Communication parameter information between UE (User Equipment, user side) and a VLC device is determined by means of negotiation by using the cellular network, so as to establish a downlink VLC link that is between the VLC device and the UE and that is disposed on the street lamp 3. Then, the VLC device sends received data to the UE by using the downlink VLC link. A specific process is not repeatedly described herein.

Referring to FIG. 12, FIG. 12 shows a block diagram of a data transmission apparatus according to an embodiment of the present invention. The apparatus is applied to a terminal. As shown in FIG. 12, the apparatus may include an obtaining unit 110, a determining unit 120, a link establishing unit 130, and a receiving unit 140.

The obtaining unit 110 is configured to search for a VPAN, and obtains identification information corresponding to at least one found VPAN.

The determining unit 120 is configured to determine a target VPAN according to the identification information, obtained by the obtaining unit, of the at least one VPAN.

The link establishing unit 130 is configured to obtain communication parameter information of the target VPAN, and establish, according to a communication parameter of the target VPAN, a downlink VLC link between the terminal and a visible light communications VLC device corresponding to the target visible light network.

The receiving unit 140 is configured to receive data sent by the VLC device by using the downlink VLC link.

The data transmission apparatus provided in this embodiment searches for a VPAN, determines a target VPAN from found VPANs, obtains communication parameter information of the target VPAN, and establishes a downlink VLC link between the apparatus and a VLC device corresponding to the target VPAN. Then, a terminal may receive, by using the downlink VLC link, data sent by the VLC device. Therefore, traffic intensive downlink data is forwarded to the terminal by using the downlink VLC link, and a transmission rate of an entire wireless communications network is increased. In addition, the terminal may directly obtain a VLC communication parameter from a received VLC signal or negotiate a VLC communication parameter by using a non-visible light wireless communications channel. Therefore, a terminal side does not need to have a VLC sending capability, and high VLC transmit power consumption of the terminal is avoided. This makes the terminal increase a data transmission rate without causing more noticeable power consumption.

In an embodiment of the present invention, the determining unit 120 may include a first obtaining subunit and a sending subunit.

The first obtaining subunit is configured to obtain VLC signal quality of the VPAN corresponding to the identification information.

The sending subunit is configured to send the identification information and the VLC signal quality that are corresponding to the at least one VPAN to a non-visible light wireless access point by using a non-visible light communications channel.

The receiving unit 140 is further configured to receive identification information of the target VPAN sent by the non-visible light wireless access point, where the target VPAN is determined by the non-visible light wireless access point according to the identification information and the VLC signal quality of the at least one VPAN.

In another embodiment of the present invention, the determining unit 120 includes a second obtaining subunit and a determining subunit.

The second obtaining subunit is configured to obtain VLC signal quality of each VPAN corresponding to the identification information.

The determining subunit is configured to determine a VPAN with best VLC signal quality as the target VPAN.

Optionally, in an embodiment of the present invention, the obtaining unit 110 may include a first measurement subunit and a third obtaining subunit.

The first measurement subunit is configured to measure VLC signal quality of the at least one VPAN.

The third obtaining subunit is configured to obtain identification information corresponding to at least one VPAN whose VLC signal quality meets a preset condition.

The third obtaining subunit is specifically configured to: when the VPAN includes multiple VLC cells, obtain, by the terminal, identification information corresponding to a VLC cell with best VLC signal quality in the multiple VLC cells.

In another embodiment of the present invention, the obtaining unit 110 may include a second measurement subunit and a fourth obtaining subunit.

The receiving unit 140 is further configured to receive, by using a non-visible light wireless communications channel, a VPAN search command delivered by the non-visible light wireless access point.

The second measurement subunit is configured to measure VLC signal quality of the at least one VPAN according to the VPAN search command.

The second measurement subunit is specifically configured to: if the VPAN search command includes specified VPAN identification information, measure VLC signal quality of a VPAN corresponding to the specified VPAN identification information; or if the VPAN search command does not include specified VPAN identification information, measure VLC signal quality of a VPAN whose VLC signal can be received by the terminal.

The fourth obtaining subunit is configured to obtain identification information corresponding to at least one VPAN whose VLC signal quality meets a preset condition.

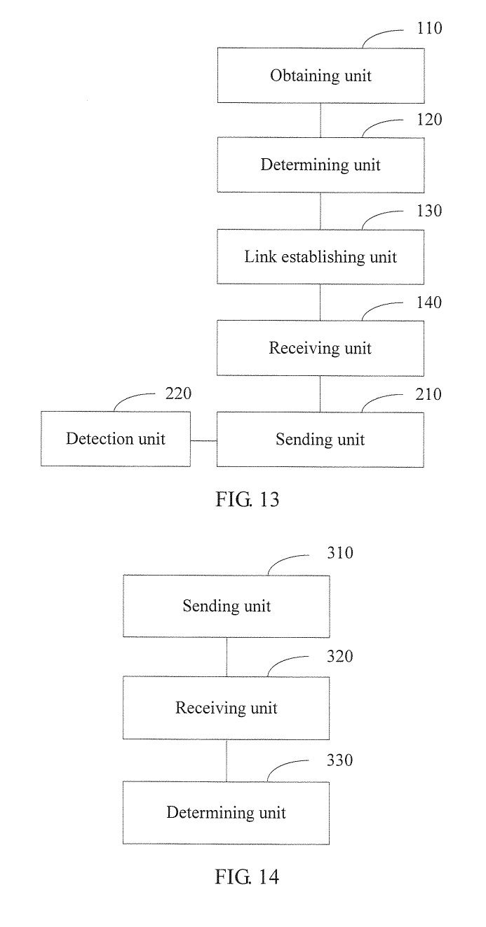

Referring to FIG. 13, FIG. 13 shows a block diagram of another data transmission apparatus according to an embodiment of the present invention. As shown in FIG. 13, on a basis of the embodiment shown in FIG. 12, the apparatus further includes a sending unit 210.

The sending unit 210 is configured to: when the receiving unit 140 incorrectly receives data that is sent by the VLC device corresponding to the target VPAN by using the downlink VLC link, send a first acknowledgment message to the non-visible light wireless access point by using the non-visible light wireless communications channel, where the first acknowledgment message is used to instruct the non-visible light wireless access point to instruct the VLC device to retransmit the data.

In the data transmission apparatus provided in this embodiment, when a terminal does not correctly receive data that is sent by using a downlink VLC link by a VLC device corresponding to a target VPAN, the terminal sends a first acknowledgment message to a non-visible light wireless AP, and the non-visible light wireless AP instructs the VLC device to resend the data. This improves correctness of data transmission.

Optionally, the data transmission apparatus shown in FIG. 13 may further include a detection unit 220.

The detection unit 220 is configured to detect whether a VPAN in which the terminal is located changes.

The sending unit 210 is further configured to: when the detection unit detects that the VPAN in which the terminal is located changes, send a VPAN handover request message to the non-visible light wireless access point by using the non-visible light wireless communications channel. The VPAN handover request message carries identification information of a new VPAN.

The receiving unit 140 is further configured to receive a VPAN handover response message sent by a VLC device corresponding to the new VPAN, and hand over to the new VPAN, where the VPAN handover response message carries communication parameter information of the new VPAN.

In the data transmission method provided in this embodiment, a detection unit detects a change of a VPAN in which the detection unit is located, and reports a VPAN in which the detection unit is currently located to a non-visible light wireless AP by using a non-visible light wireless communications channel. A terminal and the non-visible light wireless AP determine a VLC parameter by means of negotiation by using a non-visible light wireless communications channel, so as to implement a VPAN handover.

Referring to FIG. 14, FIG. 14 shows a block diagram of a data transmission apparatus according to an embodiment of the present invention. The apparatus is applied to a non-visible light wireless access point. As shown in FIG. 14, the apparatus includes a sending unit 310, a receiving unit 320, and a determining unit 330.

The sending unit 310 is configured to send a VPAN search command to a terminal, where the VPAN search command is used to instruct the terminal to search for a VPAN and obtain identification information corresponding to a found VPAN.

The receiving unit 320 is configured to receive identification information corresponding to at least one VPAN found by the terminal.

The determining unit 330 is configured to determine a target VPAN according to the identification information of the at least one VPAN.

In an embodiment of the present invention, the determining unit 330 includes a first sending subunit and a first receiving subunit.

The first sending unit is configured to send a first instruction message to a VLC device corresponding to the target VPAN, where the first instruction message is used to instruct the VLC device to send data to the terminal.

The first receiving unit is configured to receive a second acknowledgment message sent by the VLC device, where the second acknowledgment message includes communication parameter information of the target VPAN.

The first sending unit is further configured to send the communication parameter information of the target VPAN to the terminal by using a non-visible light wireless communications channel.

The sending unit 310 is further configured to send the communication parameter information of the target VPAN to the terminal, where the communication parameter information of the target VPAN is used to establish a downlink visible light communications VLC link between the terminal and a visible light communications VLC device corresponding to the target VPAN.

The sending unit 310 is further configured to send data to the VLC device, where the data is sent by the VLC device to the terminal by using the downlink VLC link.

In an embodiment of the present invention, the sending unit 310 includes a first determining subunit and a second sending subunit.

The first determining subunit is configured to determine data that is in downlink data and that is forwarded to the terminal by using the downlink VLC link.

The second sending subunit is configured to directly send the data that is forwarded to the terminal by using the VLC link to the VLC device corresponding to the target VPAN.

In another embodiment of the present invention, the sending unit 310 includes a second determining subunit and a third sending subunit.

The second determining subunit is configured to determine the data that is in the downlink data and that is forwarded to the terminal by using the downlink VLC link.

The third sending unit is configured to send a downlink data forwarding message to a gateway device, so that the gateway device directly sends the data that needs to be forwarded to the terminal by using the downlink VLC link to the VLC device corresponding to the target VPAN.

The downlink data forwarding message is used to instruct the gateway device to forward, to the VLC device, the data that needs to be forwarded to the terminal by using the downlink VLC link.

By using the data transmission apparatus provided in this embodiment, a non-visible light wireless AP determines a communication parameter between a terminal and a VPAN by means of negotiation with the terminal by using a non-visible light wireless communications channel. Therefore, a VLC link between the terminal and the VPAN is established, a part of traffic intensive data is forwarded to the terminal by using the VLC link, and a wireless network transmission rate is increased. Because a VLC communication parameter is determined by means of negotiation by using the non-visible light wireless communications channel, a VLC sending module does not need to be disposed inside the terminal, and high power consumption of the terminal is avoided.

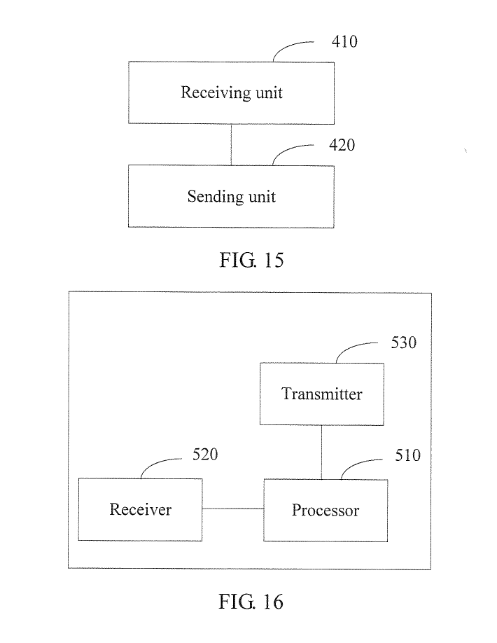

Referring to FIG. 15, FIG. 15 shows a block diagram of a data transmission apparatus according to an embodiment of the present invention. The apparatus is applied to a visible light communications device. As shown in FIG. 15, the apparatus includes a receiving unit 410 and a sending unit 420.

The receiving unit 410 is configured to receive a first instruction message sent by the non-visible light wireless access point, where the first instruction message is used to instruct the VLC device to send data to a terminal.

The sending unit 420 is configured to send a second acknowledgment message to the non-visible light wireless access point, where the second acknowledgment message includes communication parameter information of a target VPAN corresponding to the VLC device, and the communication parameter information of the target VPAN is sent by the non-visible light wireless access point to the terminal, so that the terminal establishes a downlink VLC link between the terminal and the VLC device.

The sending unit 420 is further configured to send data to the terminal by using the downlink VLC link.

Optionally, the receiving unit 410 is further configured to receive a first acknowledgment message sent by the terminal, where the first acknowledgment message is sent by the terminal to the non-visible light wireless access point by using a non-visible light wireless communications channel, and is sent by the non-visible light wireless access point to the VLC device.

The sending unit 420 is further configured to: after the receiving unit receives the first acknowledgment message sent by the terminal, resend the data to the terminal by using the downlink VLC link.

The data transmission apparatus provided in this embodiment receives apart of traffic intensive data sent by a non-visible light wireless AP, and sends the data to a terminal by using a downlink VLC link, thereby increasing a wireless network transmission rate. In addition, a VLC parameter is determined by means of negotiation by using a non-visible light wireless communications channel. Therefore, a VLC sending module does not need to be disposed inside the terminal, and high power consumption of the terminal is avoided.

Referring to FIG. 16, FIG. 16 shows a block diagram of a terminal according to an embodiment of the present invention. As shown in FIG. 16, the terminal includes a processor 510 and a receiver 520 connected to the processor 510.

The processor 510 is configured to search for a VPAN, and obtain identification information corresponding to at least one found VPAN; determine a target VPAN according to the identification information of the at least one VPAN; obtain communication parameter information of the target VPAN, and establish, according to a communication parameter of the target VPAN, a downlink VLC link between the terminal and a visible light communications VLC device corresponding to the target visible light network.

In an embodiment of the present invention, when searching for the VPAN, and obtaining the identification information corresponding to the found VPAN, the processor 510 is specifically configured to measure VLC signal quality of the at least one VPAN and obtain identification information corresponding to at least one VPAN whose VLC signal quality meets a preset condition.

Optionally, when measuring the VLC signal quality of the at least one VPAN, the processor 510 is specifically configured to: when the VPAN includes multiple VLC cells, obtain, by the terminal, identification information corresponding to a VLC cell with best VLC signal quality in the multiple VLC cells.

In another embodiment of the present invention, when searching for the VPAN, and obtaining the identification information of corresponding to the found VPAN, the processor 510 is specifically configured to:

receive, by using a non-visible light wireless communications channel, a VPAN search command delivered by a non-visible light wireless AP;

measure VLC signal quality of at least one VPAN according to the VPAN search command; and

obtain identification information corresponding to at least one VPAN whose VLC signal quality meets a preset condition.

Optionally, when measuring the VLC signal quality of the at least one VPAN according to the VPAN search command, the processor 510 is specifically configured to:

if the VPAN search command includes specified VPAN identification information, measure VLC signal quality of a VPAN corresponding to the specified VPAN identification information; or

if the VPAN search command does not include the specified VPAN identification information, measure VLC signal quality of a VPAN whose VLC signal can be received by the terminal.

In another embodiment of the present invention, when determining the target VPAN according to the identification information of the at least one VPAN, the processor 510 is specifically configured to obtain VLC signal quality of each VPAN corresponding to the identification information, and determine a VPAN with best VLC signal quality as the target VPAN.

The receiver 520 is configured to receive data sent by the VLC device by using the downlink VLC link.

In an embodiment of the present invention, when determining the target VPAN according to the identification information of the at least one VPAN, the processor 510 is specifically configured to: obtain VLC signal quality of the VPAN corresponding to the identification information, and send the identification information and the VLC signal quality that are corresponding to the at least one VPAN to a non-visible light wireless access point by using a non-visible light communications channel.

The receiver 520 is further configured to receive identification information of the target VPAN sent by the non-visible light wireless access point, where the target VPAN is determined by the non-visible light wireless access point according to the identification information and the VLC signal quality of the at least one VPAN.

Optionally, the terminal shown in FIG. 16 further includes a transmitter 530 connected to the processor 510.

The transmitter 530 is configured to: when the receiving unit incorrectly receives data that is sent by the VLC device corresponding to the target VPAN by using the downlink VLC link, send a first acknowledgment message to the non-visible light wireless access point by using the non-visible light wireless communications channel, where the first acknowledgment message is used to instruct the non-visible light wireless access point to instruct the VLC device to retransmit the data.

Optionally, the processor 510 is further configured to detect whether a VPAN in which the terminal is located changes.

The transmitter 530 is further configured to: when the detection unit detects that the VPAN in which the terminal is located changes, send a VPAN handover request message to the non-visible light wireless access point by using the non-visible light wireless communications channel, where the VPAN handover request message carries identification information of a new VPAN.

The receiver 520 is further configured to receive a VPAN handover response message sent by a VLC device corresponding to the new VPAN, and hand over to the new VPAN, where the VPAN handover response message carries communication parameter information of the new VPAN.

The terminal provided in this embodiment searches for a VPAN, determines a target VPAN from found VPANs, obtains communication parameter information of the target VPAN, and establishes a downlink VLC link between the terminal and a VLC device corresponding to the target VPAN. Then, the terminal may receive, by using the downlink VLC link, data sent by the VLC device. Therefore, traffic intensive downlink data is forwarded to the terminal by using the downlink VLC link, and a transmission rate of an entire wireless communications network is increased. In addition, the terminal may directly obtain a VLC communication parameter from a received VLC signal or negotiate a VLC communication parameter by using a non-visible light wireless communications channel. Therefore, a terminal side does not need to have a VLC sending capability, and high VLC transmit power consumption of the terminal is avoided. This makes the terminal increase a data transmission rate without causing more noticeable power consumption.

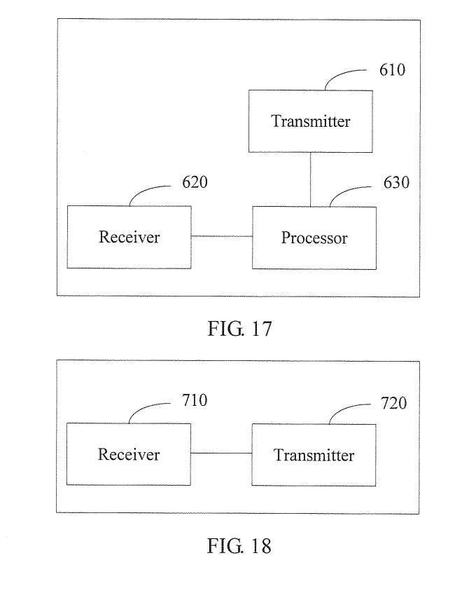

Referring to FIG. 17, FIG. 17 shows a non-visible light wireless access point according to an embodiment of the present invention. As shown in FIG. 17, the non-visible light wireless access point includes a transmitter 610, a receiver 620, and a processor 630. The transmitter 610 is connected to the processor 630, and the receiver 620 is connected to the processor 630.

The transmitter 610 is configured to send a VPAN search command to a terminal, where the VPAN search command is used to instruct the terminal to search for a VPAN and obtain identification information corresponding to a found VPAN.

The receiver 620 is configured to receive identification information corresponding to at least one found VPAN.

The processor 630 is configured to determine a target VPAN according to the identification information of the at least one VPAN.

The transmitter 610 is further configured to send communication parameter information of the target VPAN to the terminal, where the communication parameter information of the target VPAN is used to establish a downlink visible light communications VLC link between the terminal and a visible light communications VLC device corresponding to the target VPAN.

The transmitter 610 is further configured to send data to the VLC device, where the data is sent by the VLC device to the terminal by using the downlink VLC link.

In an embodiment of the present invention, when sending downlink data to the VLC device, the transmitter 610 is specifically configured to determine data that is in the downlink data and that is forwarded to the terminal by using the downlink VLC link, and directly send the data that is forwarded to the terminal by using the VLC link to the VLC device corresponding to the target VPAN.

In another embodiment of the present invention, when sending the data to the VLC device, the transmitter 610 is specifically configured to determine data that is in downlink data and that needs to be forwarded to the terminal by using the downlink VLC link, and send a downlink data forwarding message to a gateway device, so that the gateway device directly sends the data that needs to be forwarded to the terminal by using the downlink VLC link to a VLC device corresponding to the target VPAN, where the downlink data forwarding message is used to instruct the gateway device to forward, to the VLC device, the data that needs to be forwarded to the terminal by using the downlink VLC link.

Optionally, the transmitter 610 is further configured to send a first instruction message to the VLC device corresponding to the target VPAN, where the first instruction message is used to instruct the VLC device to send data to the terminal.

The receiver 620 is further configured to receive a second acknowledgment message sent by the VLC device, where the second acknowledgment message includes the communication parameter information of the target VPAN.

The transmitter 610 is further configured to send the communication parameter information of the target VPAN to the terminal by using a non-visible light wireless communications channel.

The non-visible light wireless AP provided in this embodiment determines a communication parameter between a terminal and a VPAN by means of negotiation with the terminal by using a non-visible light wireless communications channel, so as to establish a VLC link between the terminal and the VPAN. A part of traffic intensive data is forwarded to the terminal by using the VLC link, and a wireless network transmission rate is increased. Because a VLC communication parameter is determined by means of negotiation by using the non-visible light wireless communications channel, a VLC sending module does not need to be disposed inside the terminal, and high power consumption of the terminal is avoided.

Referring to FIG. 18, FIG. 18 shows a visible light communications device according to an embodiment of the present invention. The visible light communications device includes a receiver 710 and a transmitter 720 connected to the receiver 710.

The receiver 710 is configured to receive a first instruction message sent by the non-visible light wireless access point, where the first instruction message is used to instruct the VLC device to send data to a terminal.

The transmitter 720 is configured to send a second acknowledgment message to the non-visible light wireless access point, where the second acknowledgment message includes communication parameter information of a target VPAN corresponding to the VLC device, and the communication parameter information of the target VPAN is sent by the non-visible light wireless access point to the terminal, so that the terminal establishes a downlink VLC link between the terminal and the VLC device.

The transmitter 720 is further configured to send data to the terminal by using the downlink VLC link.

Optionally, the receiver 710 is further configured to receive a first acknowledgment message sent by the terminal, where the first acknowledgment message is sent by the terminal to the non-visible light wireless access point by using a non-visible light wireless communications channel, and is sent by the non-visible light wireless access point to the VLC device.

The transmitter 720 is further configured to: after the receiving unit receives the first acknowledgment message sent by the terminal, resend the data to the terminal by using the downlink VLC link.

The visible light communications device provided in this embodiment receives a part of traffic intensive data sent by a non-visible light wireless AP, and then sends the data to a terminal by using a downlink VLC link, thereby increasing a wireless network transmission rate. In addition, a VLC parameter is determined by means of negotiation by using a non-visible light wireless communications channel. Therefore, a VLC sending module does not need to be disposed inside the terminal, and high power consumption of the terminal is avoided.

The embodiments in this specification are all described in a progressive manner, for same or similar parts in the embodiments, reference may be made to these embodiments, and each embodiment focuses on a difference from other embodiments. Especially, apparatus or system embodiments are basically similar to a method embodiment, and therefore are described briefly; for related parts, reference may be made to partial descriptions in the method embodiment. The described apparatus and system embodiments are merely examples. The units described as separate parts may or may not be physically separate, and parts displayed as units may or may not be physical units, may be located in one position, or may be distributed on a plurality of network units. Some or all the modules may be selected according to actual needs to achieve the objectives of the solutions of the embodiments. A person of ordinary skill in the art may understand and implement the embodiments of the present invention without creative efforts.

The present invention can be described in the general context of executable computer instructions executed by a computer, for example, a program module. Generally, the program unit includes a routine, program, object, component, data structure, and the like for executing a particular task or implementing a particular abstract data type. The present invention may also be practiced in distributed computing environments in which tasks are performed by remote processing devices that are connected through a communications network. In a distributed computing environment, program modules may be located in both local and remote computer storage media including storage devices.

It should be noted that in this specification, relational terms such as first and second are only used to distinguish one entity or operation from another, and do not necessarily require or imply that any actual relationship or sequence exists between these entities or operations. Moreover, the terms “include”, “contain”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

The foregoing descriptions are merely specified implementation manners of the present invention. It should be noted that a person of ordinary skill in the art may make several improvements or polishing without departing from the principle of the present invention and the improvements or polishing shall fall within the protection scope of the present invention.

What is claimed is:

1. A data transmission method, comprising:
searching, by a terminal, for a visible light network, and obtaining identification information corresponding to at least one found visible light network;
determining, by the terminal, a target visible light network according to the identification information of the at least one visible light network;
obtaining, by the terminal, communication parameter information of the target visible light network, and establishing, according to a communication parameter of the target visible light network, a downlink visible light communications (VLC) link between the terminal and a VLC device corresponding to the target visible light network; and
receiving, by the terminal, data sent by the VLC device by using the downlink VLC link.

2. The method according to claim 1, wherein determining, by the terminal, a target visible light network according to the identification information of the at least one visible light network comprises:
obtaining, by the terminal, a VLC signal quality of the visible light network corresponding to the identification information;
sending, by the terminal by using a non-visible light communications channel, the identification information and the VLC signal quality that are corresponding to the at least one visible light network to a non-visible light wireless access point; and
receiving, by the terminal, identification information of the target visible light network and that is sent by the non-visible light wireless access point, wherein
the target visible light network is determined by the non-visible light wireless access point according to the identification information and the VLC signal quality of the at least one visible light network.

3. The method according to claim 1, wherein determining, by the terminal, a target visible light network according to the identification information of the at least one visible light network comprises:
obtaining, by the terminal, a VLC signal quality of each visible light network corresponding to the identification information; and
determining, by the terminal, a visible light network with best VLC signal quality as the target visible light network.

4. The method according to claim 1, wherein searching, by a terminal, for a visible light network, and obtaining identification information corresponding to at least one found visible light network comprises:
measuring, by the terminal, the VLC signal quality of the at least one visible light network; and
obtaining, by the terminal, identification information corresponding to at least one visible light network whose VLC signal quality meets a preset condition.

5. The method according to claim 4, wherein obtaining, by the terminal, identification information corresponding to at least one visible light network whose VLC signal quality meets a preset condition comprises:
when the visible light network comprises multiple VLC cells, obtaining, by the terminal, identification information corresponding to a VLC cell with best VLC signal quality in the multiple VLC cells.

6. The method according to claim 1, wherein searching, by a terminal, for a visible light network, and obtaining identification information corresponding to at least one found visible light network comprises:
receiving, by the terminal by using a non-visible light wireless communications channel, a visible light network search command delivered by a non-visible light wireless access point;
measuring, by the terminal, a VLC signal quality of the at least one visible light network according to the visible light network search command; and
obtaining, by the terminal, identification information corresponding to at least one visible light network whose VLC signal quality meets a preset condition.

7. The method according to claim 6, wherein measuring, by the terminal, a VLC signal quality of the at least one visible light network according to the visible light network search command comprises:
if the visible light network search command comprises specified visible light network identification information, measuring, by the terminal, a VLC signal quality of a visible light network corresponding to the specified visible light network identification information; or
if the visible light network search command does not comprise specified visible light network identification information, measuring, by the terminal, a VLC signal quality of a visible light network whose VLC signal can be received.

8. The method according to claim 1, further comprising:
when the terminal incorrectly receives data that is sent by the VLC device corresponding to the target visible light network by using the downlink VLC link, sending, by the terminal, a first acknowledgment message to the non-visible light wireless access point by using the non-visible light wireless communications channel, wherein the first acknowledgment message is used to instruct the non-visible light wireless access point to instruct the VLC device to retransmit the data.

9. The method according to claim 1, further comprising:
when detecting that a visible light network in which the terminal is located changes, sending, by the terminal, a visible light network handover request message to the non-visible light wireless access point by using the non-visible light wireless communications channel, wherein the visible light network handover request message carries identification information of a new visible light network; and
receiving, by the terminal, a visible light network handover response message sent by a VLC device corresponding to the new visible light network, and handing over to the new visible light network, wherein
the visible light network handover response message carries communication parameter information of the new visible light network.

10. A data transmission method, comprising:
sending, by a non-visible light wireless access point, a visible light network search command to a terminal, wherein the visible light network search command is used to instruct the terminal to search for a visible light network and obtain identification information of a found visible light network;
receiving, by the non-visible light wireless access point, identification information corresponding to at least one visible light network found by the terminal;
determining, by the non-visible light wireless access point, a target visible light network according to the identification information of the at least one visible light network;
sending, by the non-visible light wireless access point, communication parameter information of the target visible light network to the terminal, wherein the communication parameter information of the target visible light network is used to establish a downlink visible light communications (VLC) link between the terminal and a VLC device corresponding to the target visible light network; and
sending, by the non-visible light wireless access point, data to the VLC device, wherein the data is configured to be sent by the VLC device to the terminal by using the downlink VLC link.

11. The method according to claim 10, wherein sending, by the non-visible light wireless access point, communication parameter information of the target visible light network to the terminal comprises:
sending, by the non-visible light wireless access point, a first instruction message to the VLC device corresponding to the target visible light network, wherein the first instruction message is used to instruct the VLC device to send data to the terminal;
receiving, by the non-visible light wireless access point, a second acknowledgment message sent by the VLC device, wherein the second acknowledgment message comprises the communication parameter information of the target visible light network; and
sending, by the non-visible light wireless access point, the communication parameter information of the target visible light network to the terminal by using a non-visible light wireless communications channel.

12. The method according to claim 10, wherein sending, by the non-visible light wireless access point, data to the VLC device comprises:
determining, by the non-visible light wireless access point, data that is in downlink data and that needs to be forwarded to the terminal by using the downlink VLC link; and
directly sending, by the non-visible light wireless access point, the data that needs to be forwarded to the terminal by using the VLC link to the VLC device corresponding to the target visible light network.

13. The method according to claim 10, wherein sending, by the non-visible light wireless access point, data to the VLC device comprises:
determining, by the non-visible light wireless access point, data that is in downlink data and that needs to be forwarded to the terminal by using the downlink VLC link; and
sending, by the non-visible light wireless access point, a downlink data forwarding message to a gateway device, so that the gateway device directly sends the data that needs to be forwarded to the terminal by using the downlink VLC link to the VLC device corresponding to the target visible light network, wherein
the downlink data forwarding message is used to instruct the gateway device to forward, to the VLC device, the data that needs to be forwarded to the terminal by using the downlink VLC link.

14. A data transmission method, comprising:
receiving, by a visible light communications (VLC) device, a first instruction message sent by a non-visible light wireless access point, wherein the first instruction message is used to instruct the VLC device to send data to a terminal;
sending, by the VLC device, a second acknowledgment message to the non-visible light wireless access point, wherein the second acknowledgment message comprises communication parameter information of a target visible light network corresponding to the VLC device, and the communication parameter information of the target visible light network is sent by the non-visible light wireless access point to the terminal, so that the terminal establishes a downlink VLC link between the terminal and the VLC device; and
sending, by the VLC device, data to the terminal by using the downlink VLC link.

15. The method according to claim 14, further comprising:
after receiving a first acknowledgment message sent by the terminal, resending, by the VLC device, the data to the terminal by using the downlink VLC link, wherein
the first acknowledgment message is sent by the terminal to the non-visible light wireless access point by using a non-visible light wireless communications channel, and is sent by the non-visible light wireless access point to the VLC device.

16. A terminal, comprising:
a processor, configured to:
search for a visible light network, and obtain identification information corresponding to at least one found visible light network;
determine a target visible light network according to the identification information of the at least one visible light network;
obtain communication parameter information of the target visible light network, and establish, according to a communication parameter of the target visible light network, a downlink VLC link between the terminal and a visible light communications VLC device corresponding to the target visible light network; and
a receiver, configured to receive data sent by the VLC device by using the downlink VLC link.

17. The terminal according to claim 16, wherein
when determining the target visible light network according to the identification information of the at least one visible light network, the processor is configured to:
obtain a VLC signal quality of the visible light network corresponding to the identification information, and send the identification information and the VLC signal quality that are corresponding to the at least one visible light network to a non-visible light wireless access point by using a non-visible light communications channel; and
the receiver is further configured to receive identification information that is of a target visible light network and that is sent by the non-visible light wireless access point, wherein the target visible light network is determined by the non-visible light wireless access point according to the identification information and the VLC signal quality of the at least one visible light network.

18. The terminal according to claim 16, wherein when determining the target visible light network according to the identification information of the at least one visible light network, the processor is configured to:
obtain a VLC signal quality of each visible light network corresponding to the identification information, and determine a visible light network with best VLC signal quality as the target visible light network.

19. A non-visible light wireless access point, comprising:
a transmitter, configured to send a visible light network search command to a terminal, wherein the visible light network search command is used to instruct the terminal to search for a visible light network, and obtain identification information corresponding to a found visible light network;
a receiver, configured to receive identification information corresponding to at least one visible light network found by the terminal; and
a processor, configured to determine a target visible light network according to the identification information of the at least one visible light network; wherein
the transmitter is further configured to:
send communication parameter information of the target visible light network to the terminal, wherein the communication parameter information of the target visible light network is used to establish a downlink visible light communications (VLC) link between the terminal and a VLC device corresponding to the target visible light network; and
send data to the VLC device, wherein the data is sent by the VLC device to the terminal by using the downlink VLC link.

20. A visible light communications (VLC) device, comprising:
a receiver, configured to receive a first instruction message sent by a non-visible light wireless access point, wherein the first instruction message is used to instruct the VLC device to send data to a terminal; and
a transmitter, configured to send a second acknowledgment message to the non-visible light wireless access point, wherein the second acknowledgment message comprises communication parameter information of a target visible light network corresponding to the VLC device, and the communication parameter information of the target visible light network is sent by the non-visible light wireless access point to the terminal, so that the terminal establishes a downlink VLC link between the terminal and the VLC device; wherein
the transmitter is further configured to send data to the terminal by using the downlink VLC link.
